(19) United States
(12) Patent Application Publication
(10) Pub. No.: US 2007/0251325 A1
(43) Pub. Date: Nov. 1, 2007

(54) Impulse Response Pressure Transducer

(76) Inventor: Joseph King, Upland, CA (US)

Correspondence Address: Joseph King, 1669 Foxgrove Ct, Upland, CA, 91784, US

(21) Appl. No.: 11/380,341

(22) Filed: Apr. 26, 2006

(51) Int. Cl. G01L 11/00

(52) U.S. Cl. 73/702

(57) ABSTRACT

A pressure transducer that does not breech the vessel wall is described. The pressure is determined by introducing an impulse to cause vibrations in the vessel, measuring the vibration, and determining the pressure inside the vessel as a function of one or more frequencies of the measured vibrations in the vessel wall. A PVDF transducer sensor may be used to measure the vibrations, and the vibration data may be transformed from the time domain to the frequency domain using a Digital Fourier transform. Mechanisms and hardware used to measure and calculate the internal pressure may include dedicated laboratory hardware, PC and PDA based systems, or a fully embedded microcontroller with accuracy and cost that rivals current technology.

### CROSS-REFERENCED TO RELATED APPLICATIONS

There are no cross-referenced or related applications.

### BACKGROUND OF THE INVENTION

This invention relates generally to testing and measurement techniques, and in particular to testing the pressure inside a sealed vessel without breaching the wall of the sealed vessel.

Some pressure vessels for military and commercial applications are provided under the assumption that the highly pressurized fluid inside the bottle will remain for more than 10 years with a very high degree of confidence. This high degree of confidence is usually accomplished by providing a bottle that has a minimum number of outlet ports. This implies that there is usually not a port designated for measuring pressure. There is then no way to verify if high-pressure gas is present in the bottle. In military applications where the high-pressure gas is an integral part of, for example, missile performance, the absence of the gas can cause malfunction of the missile and the loss of innocent lives.

Similarly, pressure vessels containing highly corrosive materials are applications where it is desirable to have a pressure gauge with no wetted components. Further, there is always a commercial desire to produce devices that can monitor pressure at lower costs than existing technology.

Others have considered this problem. Tittmann, U.S. Pat. No. 4,869,097, describes a pressure sensor that can operate without breaching the vessel wall. His sensor reportedly detects the resonant frequencies of the gas inside the bottle. These resonant frequencies vary with gas pressure. Therefore, the pressure can be determined from the gas resonant frequencies. In Tittmann's method and device, gas resonant frequencies are excited using a transducer that vibrates the vessel at the gas's resonant frequencies. A function generator that sweeps the frequency range of interest drives the transducer. The device requires complex electronic circuitry for generating and monitoring resonant frequencies. The electronics are relatively expensive and difficult to implement. Further, it is sometimes difficult to determine when a resonant frequency is detected when the vessel is itself being driven at the same frequency by an external device. Bronowacki, el al, U.S. Pat. No. 5,591,900, and Blackburn, et al, U.S. Pat. No. 5,351,527, have described two devices that suffer the same limitations.

Other methods and devices have been reported. Terhune, U.S. Pat. No. 4,520,654, use sonic pulse speed and attenuation to determine pressure. Parker, U.S. Pat. No. 4,473,061 use an oscillating pressure wave generated inside the vessel requiring transducers mounted inside the vessel. Shibasaki, U.S. Pat. No. 4,187,718 and Miyahara, U.S. Pat. No. 4,406,157 use the dampening characteristics of a vibrating container wall. Brown, U.S. Pat. No. 3,942,381, uses ultrasonic pulse propagation speed. All these devices are based on the detection of variations produced in the gas that are read externally sometimes through interaction with the vessel walls. The devices also require relatively complex electrical circuitry and can be difficult to calibrate.

The pressure transducer and method reported here is implemented using vessel impulse response. Here the frequency response is determined using a simple impulse stimulus and data transformation to the frequency domain. This greatly simplifies the electronics and allows inexpensive implementation with an assortment of standard equipment including microcontroller based embedded systems. This allows the production of a device that can be commercial more viable than even existing technology that requires precision mechanical devices and transducers.

### BRIEF SUMMARY OF THE INVENTION

A pressure transducer that does not breech the vessel wall is described. To avoid the problems of previous solutions, the pressure inside a vessel is sensed or measured using vessel impulse response. Increased pressure inside the vessel changes the vessel's impulse response. The measured impulse response can therefore be used to determine the pressure inside the pressure vessel.

In one embodiment, applying a simple mechanical tap on the outside of the pressure vessel can serve as the impulse. The impulse response is recorded using an appropriate transducer and data collection technique. In one embodiment, a PVDF patch is used for the transducer because of its high sensitivity and extremely low cost.

Signal processing is used to convert the data from the time domain to the frequency domain. The Fourier Transform or Digital Fourier transform are methods that can be used to transform the data to the frequency domain. Data in the frequency domain is a useful representation of the vessel's impulse response. Signal peaks in the frequency domain are correlated with the internal pressure. In one embodiment, comparison with pre-calibrated data can be used to correlate peak frequencies with the internal pressure.

The method has been demonstrated on multiple vessels of the same design and construction. Embodiments include but are not limited to dedicated laboratory hardware, PC and PDA based systems and a fully embedded microcontroller with accuracy and cost that rivals current technology.

### BRIEF DESCRIPTION OF THE SEVERAL VIEWS OF THE DRAWING

FIG. 1 is a block diagram of a system used to measure pressure inside a vessel, in accordance with an embodiment of the invention.

FIG. 2 presents an impulse response of a spherical pressure vessel over the 0-kHz to 10-kHz frequency range. The figure includes multiple tests on a single vessel, demonstrating that a number of resonant peaks are present over the frequency range.

FIG. 3 presents an impulse response of a spherical pressure vessel over the 8-kHz to 10-kHz frequency range. The figure includes multiple tests on a single vessel. The scale is magnified so that the reproducibility of the method is made clear.

FIG. 4 displays a calibration curve for six “identical” spherical pressure vessels filled with different pressures of nitrogen gas. The precision and accuracy of the method are made clear.

### DETAILED DESCRIPTION OF THE INVENTION

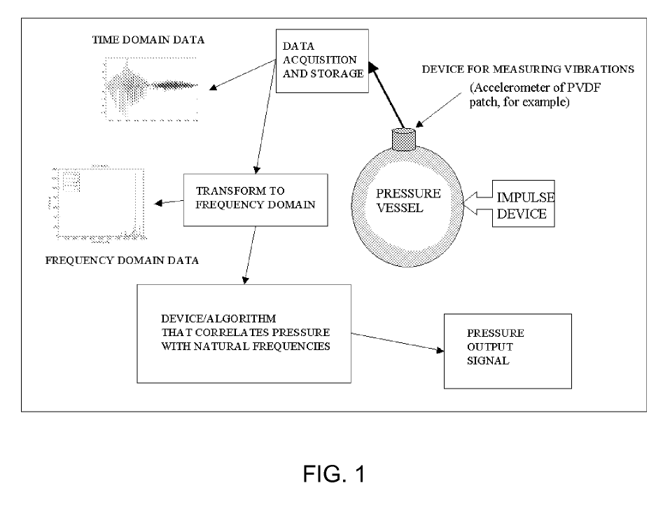

In one embodiment, a system for measuring the pressure of a vessel comprises: a device for initiating an impulse on the vessel's wall, a device for sensing changes in the impulse response of the vessel, a data acquisition and signal processing system, a method of correlating the impulse response with the internal pressure and an output device. FIG. 1 summarizes such an embodiment.

A somewhat arbitrary device may be used to impact the vessel. The suitable impact device need only excite the resonant frequencies of interest, and a very light impact may be sufficient. Accordingly, the device may be a hammer or other object used by an operator to strike the vessel, or the device may be incorporated into the system for automatically providing an impulse to the vessel wall. A great many mechanisms exist for providing an appropriate impulse, including a solenoid, a piezoelectric element, and a simple mechanical spring assembly driven by a stepper motor.

The sensing device may be a transducer (e.g., an accelerometer, micro-electro-mechanical or PVDF patch) or other suitable device for measuring vibration in the vessel wall. The sensing device may be placed at an appropriate location on the outside surface of the vessel or may be incorporated into the wall of the vessel, so that it can measure the wall's vibration.

In one embodiment, the sensing device is a polyvinylidene fluoride (PVDF) patch. When properly prepared, the PVDF patch will output a voltage when the patch is stretched or deformed by the motion of the vessel. The sensitivity of the device is equivalent to the best available accelerometers, and the cost of the patch is very low. In addition, the PVDF transducer can be attached with simple adhesives adding to the economical advantage. The use of the PVDF patch makes the preferred embodiment of this device and method cost competitive with virtually all existing technology used to measure pressure.

The data acquisition and processing system is coupled to the sensing device for receiving data about the vibrations of the vessel and processing those data as described herein to determine the pressure inside of the vessel. The data acquisition system may include a computer system having an interface (e.g., a PCI) card for receiving data from the sensing device. The system is further programmed to collect a vibration signal from the sensing device in the time domain and change the signal from the time domain to the frequency domain. Converting a signal from the time domain into the frequency domain can be achieved by using, for example, a Fourier Transform or a Fast Fourier Transform or a Digital Fourier Transform and can be performed in hardware or in software.

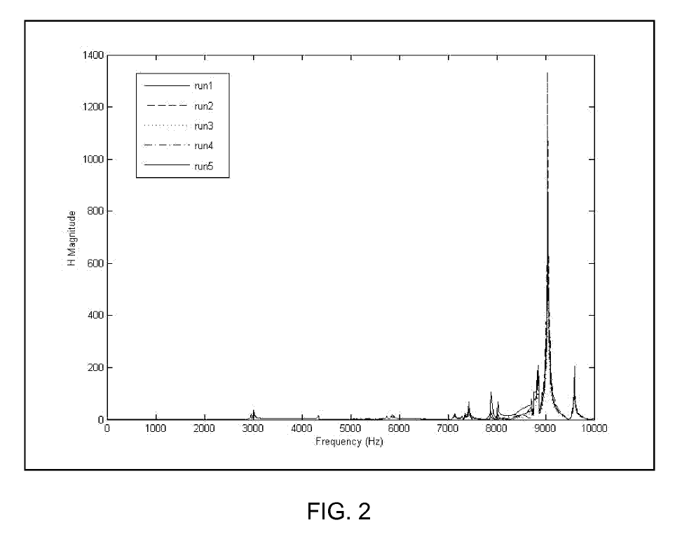

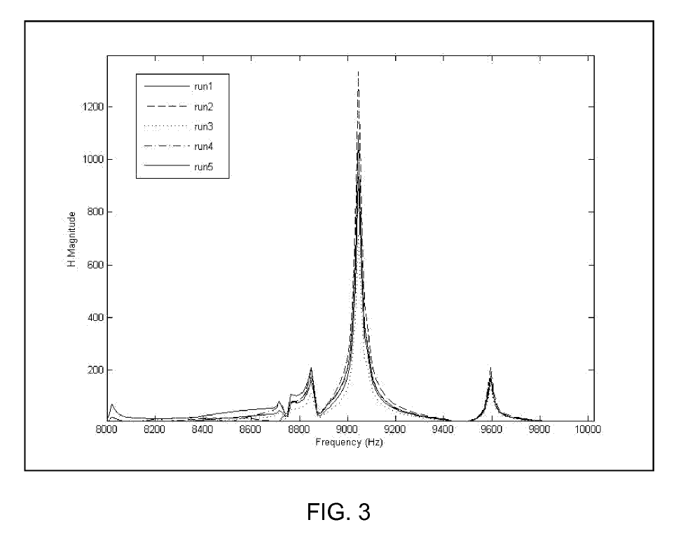

The output of the sensing device is amplified and filtered. In one embodiment, this signal processing is done in hardware. In another embodiment, the signal processing could be done with software. The signal is collected in the time domain. When processed to the frequency domain, the impulse response of the system is readily apparent. A typical impulse response for pressure vessels is presented in FIG. 2. The 9-kHz region is expanded and presented in FIG. 3. The quality of the data is evident. The signal to noise ratio is greater than 1000 and the consistency of the peak value is better than 1 Hz for the 9-kHz peak.

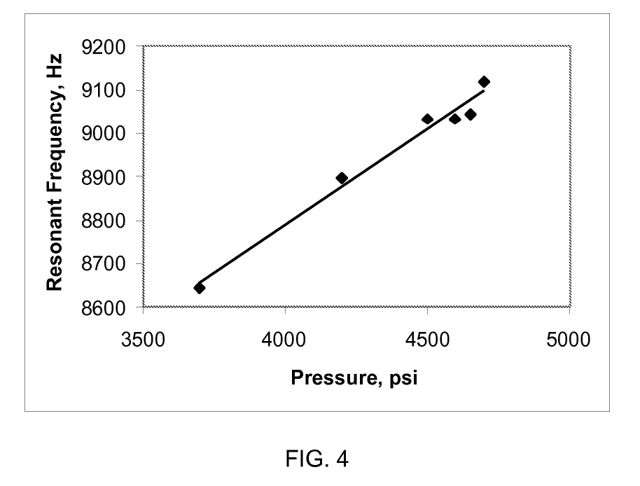

Empirical calibration can be done with either a single bottle by varying fill pressures or evaluation of various bottles with fixed fill pressures. The results of calibration of six ‘identical’ vessels are shown in FIG. 4 for the major peak in the 9-kHz range. The results indicate the technique is sufficiently accurate and precise to have commercial application and value.

There are at least three causes for peaks in the impulse response. One source of peaks is due to the resonant frequencies of the gas inside the bottle. Tittmann, U.S. Pat. No. 4,869,097, and others have described this effect. In addition, the vessel will experience structural resonance adding to the impulse response. Resonant frequencies in the vessel structure will change depending on the stress in the vessel walls. The stress in the bottle will increase with increase in internal pressure. This effect is described by Archer, R. R., “On the Influence of Uniform Stress States on the Natural Frequencies of Spherical Shells,” Transactions of the ASME, Journal of Applied Mechanics, September 1962, pp. 502-505, (1962). In addition, these two effects can interact to create resonant frequencies of the vessel-gas system. The device and method described here is capable of detecting and using resonant frequencies from all sources. This is an inherent quality of the impulse response method.

The device and method related to using impulse response to measure internal pressure have been illustrated and described. Several embodiments have been described. Other embodiments and implementations are possible. For example, the transducer used to measure pressure need not be an accelerometer. In addition, a large assortment of mechanical and electro-mechanical devices can by used to impart the impulse. Equivalent elements may be substituted for the ones discussed and illustrated herein. Therefore, the embodiments presented here should not be considered inclusive.

I claim:

1. A method for measuring a pressure inside a vessel without breeching a wall of the vessel, the method comprising:
introducing an impulse to the vessel to cause vibrations in the vessel;
measuring the vibrations in the vessel, the vibrations having one or more frequencies; and
determining the pressure inside the vessel as a function of one or more frequencies of the measured vibrations in the vessel wall.

2. The method of claim 1, wherein introducing the impulse to the vessel comprises applying a mechanical tap to the wall of the vessel.

3. The method of claim 1, wherein determining the pressure inside the vessel comprises:
transforming the measured vibrations into the frequency domain;
correlating one or more frequencies of signal peaks of the measured vibrations in the frequency domain with a correlated pressure; and
determining the internal pressure of the vessel as the correlated pressure.

4. The method of claim 3, wherein the correlating comprises comparing the frequencies of the signal peaks of the measured vibrations in the frequency domain with pre-calibrated data.

5. A system for measuring a pressure inside a vessel without breeching a wall of the vessel, the apparatus comprising:
an impulse generator for striking the wall of the vessel to provide an impulse response therein;
a sensing device mechanically coupled to a wall of the vessel for measuring vibrations therein; and
a data acquisition and processing system configured to measure the vibrations in the vessel and determine the pressure inside the vessel as a function of one or more frequencies of the measured vibrations in the vessel wall.

6. The system of claim 5, wherein the sensing device is placed on an outside surface of the wall of the vessel.

7. The system of claim 5, wherein the sensing device is incorporated into the wall of the vessel.

8. The system of claim 5, wherein the sensing device comprises a PVDF patch.
